(19) United States
(12) Patent Application Publication
(10) Pub. No.: US 2013/0279363 A1
(43) Pub. Date: Oct. 24, 2013

(54) METHOD FOR TRIGGERING APERIODIC CHANNEL STATE INFORMATION FEEDBACK

(71) Applicants: Lei Huang, Pudong (CN); Ming Ding, Pudong (CN); Zeng Yang, Pudong (CN); Renmao Liu, Pudong (CN)

(72) Inventors: Lei Huang, Pudong (CN); Ming Ding, Pudong (CN); Zeng Yang, Pudong (CN); Renmao Liu, Pudong (CN)

(73) Assignee: SHARP KABUSHIKI KAISHA, Osaka-shi, Osaka (JP)

(21) Appl. No.: 13/978,761

(22) PCT Filed: Jan. 10, 2012
(86) PCT No.: PCT/JP2012/050656

§ 371 Date: Jul. 9, 2013

(30) Foreign Application Priority Data
Jan. 10, 2011 (CN) 201110008015.9

(51) Int. Cl. H04W 24/10

(52) U.S. Cl. CPC H04W 24/10
USPC 370/252

(57) ABSTRACT

The present disclosure provides a method for triggering aperiodic Channel State Information (CSI) feedback used in a multiple coordinated cells multiple component carriers system. According to the present disclosure, a base station firstly semi-statically configures a user equipment to CoMP transmission modes, and/or information on measurement cells, and/or information on measurement component carriers by a high layer signaling (RRC signaling). Then, the base station dynamically initiates an aperiodic CSI feedback request to the user equipment by downlink control information (through PDCCH). When receiving the aperiodic CSI feedback request transmitted by the base station, the user equipment transmits measured aperiodic CSI to the base station through an uplink channel (PUSCH or PUCCH). According to the present invention, the method for triggering aperiodic CSI feedback in CoMP transmission modes can be flexibly configured, and good backward compatibility can be obtained at the same time. The above method is simple and effective, the system design complexity is low, and the design requirements for practical systems and LTE-Advanced evolved systems are met.

### TECHNICAL FIELD

The present disclosure relates to mobile communication technology, and more particularly to a method for triggering aperiodic Channel State Information (CSI) feedback which is used in a communication system employing carrier aggregation technique and Coordinated Multi-Point (CoMP) transmission modes.

### BACKGROUND ART

In April 2008, the 3^{rd} Generation Partnership Project (3GPP) organization held a meeting in Shenzhen, China on a topic of IMT-Advanced, the next generation international mobile communication system. In this meeting, a lot of multi-national companies analyzed the requirements in 4G mobile communication systems, and discussed about potential key techniques. Among various proposals, one technique named “Coordinated Multi-Point (CoMP) transmission” is widely considered and supported. The key idea of CoMP is to use multiple base stations at the same time to provide communication services for one or more user equipments so as to improve data transmission rates of user equipments located at boundaries of cells. In the subsequent meetings held by 3GPP Radio Access Network Working Group 1 (RAN1), CoMP transmission modes and related feedback modes are discussed. In the up-to-date 3GPP Technical Report, 3GPP TR 36.814 (3GPP TSG RAN E-UTRA Further advancements for E-UTRA physical layer aspects (Release 9)), CoMP modes are categorized into two types. One of these types is called as Joint Processing, i.e., the user equipment can receive data transmission from any one point (i.e., any one base station) performing the CoMP transmissions. Joint Processing further includes two modes, Joint Transmission and Dynamic Cell Selection. Joint Transmission indicates that at a certain time instant, multiple coordinated base stations transmit data for a certain user equipment at the same time. Dynamic Cell Selection indicates that at a certain time instant, one of coordinated base stations is selected to transmit data for a certain user equipment. The other of these types is called as Coordinated Scheduling and/or Beamforming, i.e., by coordinated scheduling and/or beamforming with multiple coordinated base stations, a serving base station transmits data to a user equipment. Additionally, in 3GPP TR 36.814, feedback modes for supporting CoMP transmission are correspondingly categorized, a first mode is explicit CSI feedback, a second mode is implicit CSI feedback, and a third mode is CSI estimation with Sounding RS (SRS) by means of channel reciprocity. The above three feedback modes can be freely combined to effectively provide CSI feedback for CoMP transmission. At the same time, this technical report also indicates that an independent feedback based on a single cell performed over uplink resource of a serving base station will be used as a reference for CoMP transmission feedback, i.e., a user equipment respectively feedbacks CSI of adjacent coordinated cells over uplink resource of a serving cell. Although a framework for CoMP transmission feedback mechanism had been decided, detailed embodiments were not agreed. Finally, due to limited time, more standardizing works for CoMP transmission are reserved to be discussed in subsequent releases.

In addition to CoMP transmission technique, LTE-Advanced system also introduces a new technique called as Carrier Aggregation for supporting data transmission over wider system bandwidth. For example, in Reference R1-082468 (Ericsson, Carrier aggregation in LTE-Advanced, TSG-RAN1 #53bis, 2008), LTE-Advanced system supports a system bandwidth up to 100 MHz, far wider than the 20 MHz system bandwidth of LTE system. Considering appropriate user equipment access capabilities, LTE-Advanced system can support in frequency domain both continuous spectrum bandwidth resources and non-continuous spectrum bandwidth resources. The most direct way to meet this specific requirement is to use the carrier aggregation technique, i.e., bandwidths of multiple component carriers are aggregated to form a wider system bandwidth for LTE-Advanced system. In principle, the spectrum resources on the multiple component carriers can be continuous or non-continuous. Base station and user equipment can communicate with each other over the broadband system bandwidth formed by aggregation of spectrum resources on multiple component carriers. For example, the base station and the user equipment can operate over a 100 MHz LTE-Advanced system bandwidth which can be formed by aggregation of spectrum resources of five 20 MHz component carriers. With the Carrier Aggregation technique, many new designs can be introduced for the LTE-Advanced system. The previously defined mechanisms in the LTE system need to be extended or newly designed, for example, the mechanism for triggering aperiodic CSI feedback as being focused in the present disclosure.

In LTE-system, CSI feedback mechanisms include periodic feedback and aperiodic feedback. In the periodic CSI feedback mechanism, with semi-static parameter configuration, a user equipment periodically transmits measured CSI to a base station over predefined uplink resources. In the aperiodic CSI feedback mechanism, a base station transmits trigger information timely by a dynamic control signaling, and a user equipment having received the trigger information immediately transmits measured CSI to the base station. Compared with periodic CSI feedback, aperiodic CSI feedback is faster and has a larger amount of data.

In LTE Release 8 and Release 9, aperiodic channel information feedback is triggered by dynamically setting a relevant field in a downlink control signaling. Specifically, 1-bit CSI request field in Downlink Control Information (DCI) Format 0 (i.e., UL_grant) is set to “1” to trigger the transmission of aperiodic CSI feedback over Physical Uplink Shared Channel (PUSCH) defined in LTE.

For LTE-Advanced system with Carrier Aggregation introduced, 1-bit CSI request field is not enough. LTE-advanced system can support up to 5 component carriers, and thus if only 1 bit is used for triggering, it is not clear this 1 bit is to trigger aperiodic CSI feedback of which component carrier or carriers. This issue needs to be discussed and solved. With the developing of LTE-Advanced Standardization, in RAN 1 #63 meeting, relevant issues were widely discussed, and finally concluded as follows.

For LTE-Advanced system employing Carrier Aggregation, DCI Format includes a 2-bit aperiodic CSI request field. The 2 bits of this field can represent 4 different states respectively defined as follows.

State “00” indicates, not triggering aperiodic CSI feedback;

State “01” indicates, triggering aperiodic CSI feedback of a certain downlink component carrier, wherein the certain downlink component carrier is the downlink component carrier having System Information Block Type 2 (SIB2) link (i.e., SIB2 linked) to an uplink component carrier indicated by a Carrier Indicator Field (CIF) in the current DCI. FIG. 1 shows a schematic diagram for explaining State “01” of the aperiodic CSI request field defined in LTE-Advanced. As shown in FIG. 1, Downlink Carrier #1/Uplink Carrier #A and Downlink Carrier #2/Uplink Carrier #B are two pairs of component carriers having SIB2 links. When the base station schedules and transmits DCI Format 0 on Downlink Carrier #2 to allocate resources on Uplink Carrier #A for data transmission, and at the same time, the 2-bit aperiodic CSI request field in the DCI Format 0 is “01”, then the aperiodic CSI request field triggers aperiodic CSI request of Downlink Carrier #1 having SIB2 links with the Uplink Carrier #A.

States “10” and “11”, whose meanings are pre-configured by Radio Resource Control (RRC) signaling. For example, by RRC signaling, State “10” can be configured as triggering aperiodic channel state feedbacks of all activated downlink component carriers, and State “11” can be configured as triggering aperiodic channel state feedback of a downlink component carrier on which the current DCI is located.

The above mechanisms are flexible and effective for triggering aperiodic CSI feedback in the currently defined case of multiple component carriers within a single cell. However, if aperiodic CSI feedback in the possible case of multiple component carriers within multiple cells introduced by CoMP transmission is further considered, then the above mechanisms are not applicable any more, and thus need to be further extended or even newly designed.

### SUMMARY OF INVENTION

The technical problem to be solved by the present disclosure is that, in Coordinated Multi-Point (CoMP) transmission mode, in addition to aperiodically measuring and feeding back CSI of multiple component carriers for a serving cell, there is a need for measuring and feeding back CSI of multiple component carriers for multiple adjacent coordinated cells, and in the latter case, 2-bit triggering mechanism defined in LTE-Advanced system are not well-done. The object of the present disclosure is to solve the above technical problem and to propose a triggering mechanism of aperiodic CSI feedback for multiple cells and multiple component carriers.

According to a first aspect of the present disclosure, in one embodiment, there provides a method for triggering aperiodic Channel State Information (CSI) feedback including: configuring a user equipment to an operation mode of Coordinated Multi-Point (CoMP) transmission mode by a high layer signaling; and dynamically triggering aperiodic CSI feedback of the user equipment by using a 2-bit aperiodic CSI request field in Downlink Control Information (DCI) Format.

In one embodiment, a field state “00” of the 2-bit aperiodic CSI request field is configured as not triggering aperiodic CSI feedback; a field state “01” of the 2-bit aperiodic CSI request field is configured as performing measurements and feedbacks on downlink component carriers having System Information Block Type 2 (SIB2) link (i.e., SIB2 linked) to an uplink component carrier indicated by a Carrier Indicator Field (CIF) in the current DCI in all measurement cells; a field state “10” of the 2-bit aperiodic CSI request field is configured as performing measurements and feedbacks on all component carriers in all measurement cells; and a field state “11” of the 2-bit aperiodic CSI request field is configured as performing measurements and feedbacks on all component carriers in a part of measurement cells.

In another embodiment, an additional bit and the 2-bit aperiodic CSI request field form 3-bit information for collaboratively dynamically triggering the aperiodic CSI feedback of the user equipment.

In still another embodiment, 3 carrier indicator bits and the 2-bit aperiodic CSI request field form 5-bit information for collaboratively dynamically triggering the aperiodic CSI feedback of the user equipment. Furthermore, the 3 carrier indicator bits and the 2-bit aperiodic CSI request field are hybrid encoded to dynamically trigger the aperiodic CSI feedback of the user equipment.

In yet another embodiment, a sub-frame number and the 2-bit aperiodic CSI request field are combined for collaboratively dynamically triggering the aperiodic CSI feedback of the user equipment. Furthermore, the 2-bit aperiodic CSI request field in a specified sub-frame is used for triggering the aperiodic CSI feedback of the user equipment in the CoMP transmission modes. As one example, the 2-bit aperiodic CSI request field in an odd-numbered or even-numbered sub-frame is used for triggering the aperiodic CSI feedback of the user equipment in the CoMP transmission modes.

Moreover, the part of measurement cells and/or the part of component carriers are pre-configured by a high layer signaling.

Moreover, the high layer signaling is a Radio Resource Control (RRC) signaling.

With the above proposed embodiments, the method for triggering aperiodic CSI feedback in CoMP transmission modes can be flexibly configured, and good backward compatibility can be obtained at the same time. The above method is simple and effective, the system design complexity is low, and the design requirements for practical systems and LTE-Advanced evolved systems are met.

### BRIEF DESCRIPTION OF DRAWINGS

The above and other objects, features, and advantages of the present disclosure will be clear through the following description of embodiments of the present disclosure, in conjunction with drawings in which

FIG. 1 is a schematic diagram for explaining State “01” of the aperiodic Channel State Information (CSI) request field defined in LTE-Advanced;

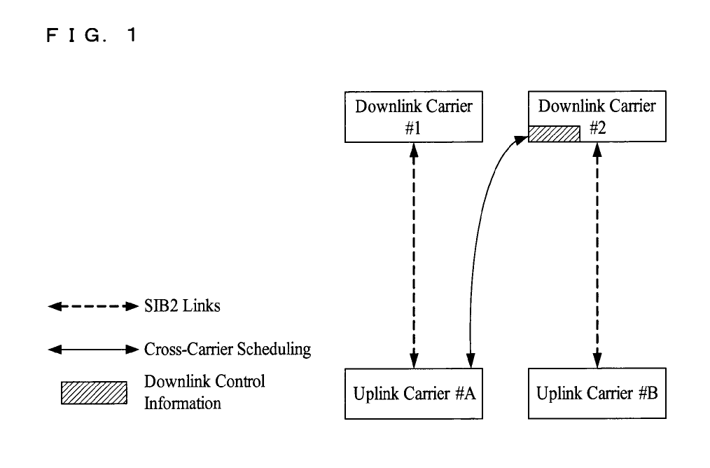

FIG. 2 is a schematic diagram showing a Coordinated Multi-Point (CoMP) transmission scenario in which the present disclosure is applicable;

FIG. 3 is a schematic diagram showing carrier allocations in the Coordinated Multi-Point (CoMP) transmission scenario in which the present disclosure is applicable;

FIG. 4 is a sequential chart showing an operation flow of the method for triggering aperiodic CSI feedback in a multiple coordinated cells, multiple component carriers system according to the present disclosure;

FIG. 5 is a schematic diagram showing one example in which a sub-frame number and an aperiodic CSI request field are combined; and

FIG. 6 is a schematic diagram showing another example in which a sub-frame number and an aperiodic CSI request field are combined.

### DESCRIPTION OF EMBODIMENTS

In the following, embodiments of the present disclosure will be detailed in conjunction with the drawings. In the following description, details and functions unnecessary to the present invention are omitted so as not to obscure the concept of the invention.

For clear and detailed explanation of the implementation steps of the present invention, some specific examples applicable to mobile communication systems supporting Carrier Aggregation technique and Coordinated Multi-Point (CoMP) transmission mode are given below, especially LTE-Advanced cellular mobile communication systems and evolved systems thereafter. Herein, it is to be noted that the present disclosure is not limited to the application exemplified in the embodiments. Rather, it is applicable to other communication systems, such as the future 5G system.

Before describing the embodiments of the present disclosure, the CoMP transmission scenario related to the present disclosure is firstly described in brief.

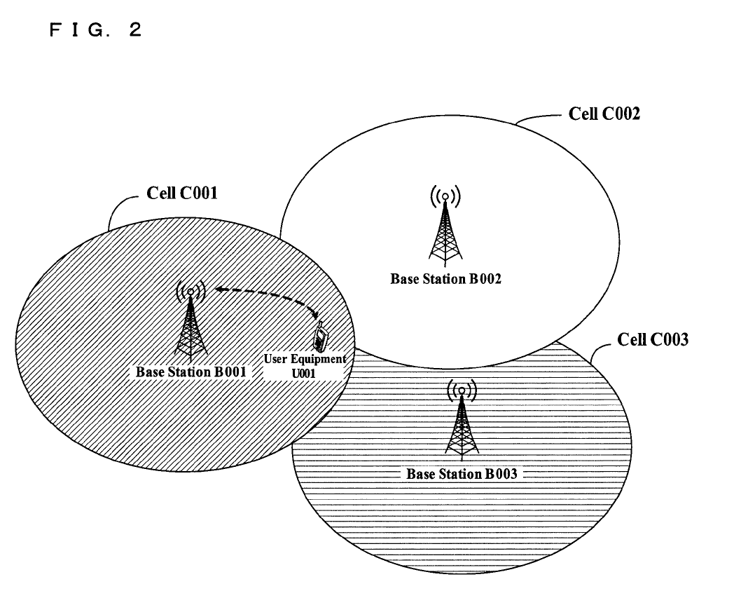

FIG. 2 is a schematic diagram of a Coordinated Multi-Point (CoMP) transmission scenario in which the present disclosure is applicable. As shown in FIG. 2, adjacent cells C001, C002 and C003 seamlessly cover a certain range. When a user equipment is located at a boundary of a cell, a base station will enable a CoMP transmission modes for the user equipment to coordinate with one or more base stations of one or more adjacent cells for performing data transmission for the user equipment. Based on definitions of CoMP transmission in LTE-Advanced, a user equipment performing CoMP transmission has one serving base station (e.g., Base Station B001 in FIG. 2), several coordinated base station (e.g., Base Station B002 and Base Station B003 in FIG. 2) and a predefined set of measurement cells (e.g., a set of three cells formed by Base Station B001, Base Station B002 and Base Station B003 in FIG. 2). Referring to FIG. 2, when User Equipment U001 in coverage of Serving Base Station B001 is located at a boundary of Cell C002 and Cell C003, the Serving Base Station B001 semi-statically configures the User Equipment U001 to CoMP transmission modes via a high layer signaling (RRC signaling). If necessary, the Base Station B001 triggers the User Equipment U001 to initiate aperiodic Channel State Information (CSI) feedback. When receiving the trigger information, the User Equipment U001 performs the aperiodic CSI feedback over specific resources. The Base Station B001 performs cell coordination based on the received aperiodic CSI feedback, e.g., the Base Station B001 determines that Base Station B002 and Base Station B003 need to be coordinated to perform joint transmission for the User Equipment U001 at the same time. At this time, the Base Station B001 may send relevant control signalings and data information to the Base Station B002 and the Base Station B003 via background signalings. Then, over specific resources, the Base Station B001, the Base Station B002 and the Base Station B003 transmit data to the User Equipment U001 at the same time. Based on the above procedure, the present disclosure focuses on how the Base Station B001 triggers the User Equipment U001 to initiate aperiodic CSI feedback.

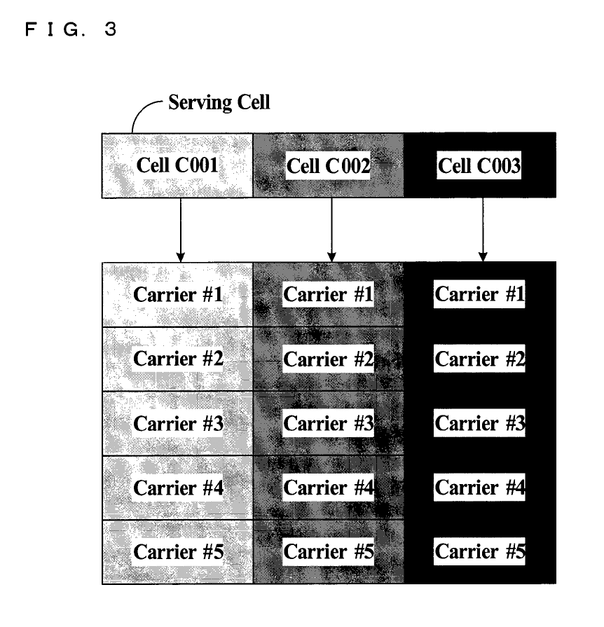

Based on the scenario shown in FIG. 2, FIG. 3 provides component carrier allocations of the respective cells (Cell C001, Cell C002 and Cell C003). The Cell C001 is a serving cell of the User Equipment U001, and the Base Station B001 of the Cell C001 is configured to operate over 5 component carriers (i.e., Carrier #1-Carrier #5) at the same time. Similarly, the Base Station B002 and the Base Station B003 of the adjacent Cell C002 and Cell C003 are also configured to operate over the same 5 component carriers (i.e., Carrier #1-Carrier #5) at the same time. Provided that the base stations to be measured by the User Equipment U001 include the Base Station B001-Base Station B003 in the Cell C001-Cell C003, then the Base Station B001 as the serving base station of the User Equipment U001 need notify the User Equipment U001 aperiodic channel state or states of which carrier or carriers of which cell or cells are to be measured and fed back.

According to the above description, the present disclosure provides a method for triggering aperiodic CSI feedback in a multiple coordinated cells, multiple component carriers system.

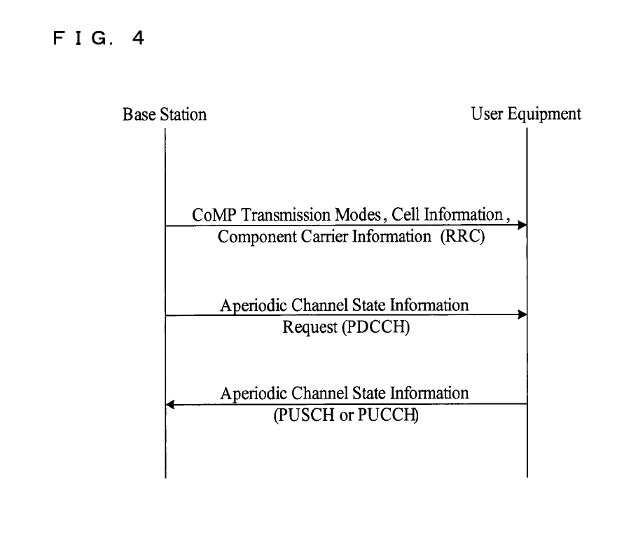

FIG. 4 is a sequential chart showing an operation flow of the method for triggering aperiodic CSI feedback in a multiple coordinated cells, multiple component carriers system according to the present disclosure. As shown in FIG. 4, a base station firstly semi-statically configures a user equipment to CoMP transmission modes, and/or information on measurement cells, and/or information on measurement component carriers by a high layer signaling (RRC signaling). Then, the base station dynamically initiates an aperiodic CSI feedback request to the user equipment by downlink control information (through Physical Downlink Control Channel (PDCCH)). When receiving the aperiodic CSI feedback request transmitted by the base station, the user equipment transmits measured aperiodic CSI to the base station through an uplink channel (PUSCH or Physical Uplink Control Channel (PUCCH)).

In more details, the present disclosure provides four methods for triggering aperiodic CSI feedback in a multiple coordinated cells multiple component carriers system. Hereunder, the embodiments of these four triggering methods will be described. However, it is to be noted that the following descriptions are only examples of the present disclosure which are specific aspects embodying the inventive idea of the present disclosure. The present disclosure is not limited to some certain details therein.

### Embodiment 1

According to Embodiment 1 of the present disclosure, a user equipment is configured to an operation mode of CoMP transmission modes by a high layer signaling (e.g., RRC signaling). Then, aperiodic CSI feedback of the user equipment is dynamically triggered by using a 2-bit aperiodic CSI request field in Downlink Control Information (DCI) Format.

Specifically, referring to definitions of the 2-bit aperiodic CSI request field in the DCI Format provided by LTE-Advanced, States “10” and “11” are configured to be used for specified CoMP transmission modes.

In the Embodiment 1 of the present disclosure, the meanings of State “00” and State “01” may refer to the aforementioned definitions in LTE-Advanced, and may be thus configured respectively as: not triggering aperiodic CSI feedback, and performing measurements and feedbacks on downlink component carriers having SIB2 link (i.e., SIB2 linked) to an uplink component carrier indicated by a Carrier Indicator Field (CIF) in the current DCI in all measurement cells. By RRC signaling, State “10” and State “11” may be configured respectively as: performing measurements and feedbacks on all component carriers in all measurement cells; and performing measurements and feedbacks on all component carriers in a part of measurement cells (specified by RRC signaling).

For example, referring to FIG. 2, Base Station B001 firstly configures User Equipment U001 to an operation mode of CoMP transmission modes by a high layer signaling (e.g., RRC signaling). Then, the Base Station B001 dynamically triggers aperiodic CSI feedback of the User Equipment U001 by a 2-bit aperiodic CSI request field in DCI Format. Field State “00” indicates not triggering the aperiodic CSI feedback of the User Equipment U001. Field State “01” indicates triggering aperiodic CSI measurements and feedbacks on downlink component carriers having SIB2 link (i.e., SIB2 linked) to an uplink component carrier indicated by a Carrier Indicator Field (CIF) in the current DCI in Cell C001-Cell C003. Field State “10” indicates triggering aperiodic CSI measurements and feedbacks on all component carriers in the Cell C001-Cell C003. Provided that a part of cells for Field State “11” is specified as the Cell 002 and Cell C003 in advance by RRC signaling, Field State “11” indicates triggering aperiodic CSI measurements and feedbacks on all component carriers in the Cell C002 and Cell C003.

Of course, RRC signaling can be not only used for specifying cells but also used for specifying component carriers. In this case, State “10” and State “11” may be configured by RRC signaling respectively as: performing measurements and feedbacks on all component carriers in a specified measurement cell or cells; and performing measurements and feedbacks on a specified component carrier or carriers (specified by RRC signaling) in a specified measurement cell or cells.

For example, referring to FIG. 2 again, Base Station B001 firstly configures User Equipment U001 to an operation mode of CoMP transmission modes by a high layer signaling (e.g., RRC signaling), and at the same time, specifies Cell C001 and Cell C002 as measurement and feedback cells. Then, the Base Station B001 dynamically triggers aperiodic CSI feedback of the User Equipment U001 by a 2-bit aperiodic CSI request field in DCI Format. Field State “00” indicates not triggering the aperiodic CSI feedback of the User Equipment U001. Field State “01” indicates triggering aperiodic CSI measurements and feedbacks on downlink component carriers having SIB2 link (i.e., SIB2 linked) to an uplink component carrier indicated by a Carrier Indicator Field (CIF) in the current DCI in Cell C001 and Cell C002. Field State “10” indicates triggering aperiodic CSI measurements and feedbacks on all component carriers in the Cell C001 and Cell C002. Provided that a part of component carriers for Field State “11” is specified as Carrier #1 and Carrier #2 by RRC signaling, Field State “11” indicates triggering aperiodic CSI measurements and feedbacks on the Carrier #1 and Carrier #2 in the Cell C001 and Cell C002.

The User Equipment U001 interprets the meaning of the 2-bit aperiodic CSI request field included in the DCI Format based on the configuration from the Base Station B001 by the high layer signaling (e.g., RRC signaling). When the User Equipment U001 is configured to normal transmission modes (i.e., non-CoMP transmission modes) by the Base Station B001, the User Equipment U001 interprets the meaning of the 2-bit aperiodic CSI request field included in the DCI Format based on definitions in LTE-Advanced systems, and correspondingly measures and feeds back aperiodic CSI. On the other hand, when the User Equipment U001 is configured to CoMP transmission modes by the Base Station B001, the User Equipment U001 interprets the meaning of the 2-bit aperiodic CSI request field included in the DCI Format based on the configuration of the high layer signaling (e.g., RRC signaling) and by using the respective definitions in the Embodiment 1 of the present disclosure.

The Embodiment 1 of the present disclosure extends the 2-bit aperiodic CSI request field included in the DCI Format from a single cell to multiple coordinated cells. With the Embodiment 1 of the present disclosure, aperiodic CSI feedback in multiple coordinated cells can be achieved without increasing complexity, and the definitions of the aperiodic CSI request field in LTE-Advanced are compatible in the maximum extent.

### Embodiment 2

According to Embodiment 2 of the present disclosure, an additional bit is introduced, together with the 2-bit aperiodic CSI request field already defined, aperiodic CSI feedback can be completely dynamically triggered for multiple coordinated cells and multiple component carriers. In the LTE-Advanced systems, 2 bits are used to indicate aperiodic CSI feedback modes in 4 different states. With one more introduced bit, a 3-bit field is used to trigger aperiodic CSI feedback and may obtain up to 8 different triggering modes.

Specifically, Field States “000”, “001”, “010” and “011” respectively correspond to States “00”, “01”, “10” and “11” defined in the LTE-Advanced systems. 4 newly added Filed States “100”, “101”, “110” and “111” due to the introduction of the one additional bit can be used for triggering aperiodic CSI feedback in CoMP transmission modes. For these 4 newly added states, 4 modes can be configured by RRC signaling in advance, and then one of these modes can be respectively and dynamically indicated by one of the above 4 states as a configured mode of a user equipment for aperiodic CSI feedback in CoMP transmission modes.

For example, the meanings of these 4 newly added Field States can be as follows.

“100” indicates, performing measurements and feedbacks on all component carriers in all measurement cells;

“101” indicates, performing measurements and feedbacks on all component carriers in a part of measurement cells (specified by RRC signaling);

“110” indicates, performing measurements and feedbacks on a part of component carriers (specified by RRC signaling) in all measurement cells; and

“111” indicates, performing measurements and feedbacks on a part of component carriers (specified by RRC signaling) in a part of measurement cells (specified by RRC signaling).

In the Embodiment 2 of the present disclosure, one additional bit is introduced. It can be a newly added 1 bit, or a pre-defined pad bit, or a reserved bit, or a bit extracted from resource allocation bits.

The Embodiment 2 of the present disclosure provides an easy and feasible solution without additionally introducing any CoMP transmission mode, and can completely dynamically trigger aperiodic CSI feedback in multiple coordinated cells multiple component carriers with increasing DCI Format payload only by 1 bit or without increasing DCI Format payload at all.

### Embodiment 3

According to Embodiment 3 of the present disclosure, 3-bit Carrier Indicator Field and 2-bit aperiodic CSI request field included and defined in DCI Format are hybrid encoded to completely dynamically trigger aperiodic CSI feedback for multiple coordinated cells multiple component carriers.

In LTE-Advanced systems, a Carrier Indicator Field of 3 bits has been introduced into DCI Format for cross-component carrier scheduling. This 3-bit Carrier Indicator Field and the CSI request field have 5 bits in total and thus may represent 32 states. According to definitions in LTE-Advanced, a system supports up to 5 carriers at the same time. Therefore, each of carriers may obtain 6 states in which 4 states may be reused for LTE-Advanced defined states of aperiodic CSI feedback, and the remaining 2 states can be used for triggering aperiodic CSI feedback for multiple coordinated cells.

TABLE 1

| | | |
|---|---|---|
| 00000 | Carrier #1 | State 1 |
| 00001 | Carrier #1 | State 2 |
| 00010 | Carrier #1 | State 3 |
| 00011 | Carrier #1 | State 4 |
| 00100 | Carrier #1 | State 5 |
| 00101 | Carrier #1 | State 6 |
| 00110 | Carrier #2 | State 1 |
| 00111 | Carrier #2 | State 2 |
| 01000 | Carrier #2 | State 3 |
| 01001 | Carrier #2 | State 4 |
| 01010 | Carrier #2 | State 5 |
| 01011 | Carrier #2 | State 6 |
| 01100 | Carrier #3 | State 1 |
| 01101 | Carrier #3 | State 2 |
| 01110 | Carrier #3 | State 3 |
| 01111 | Carrier #3 | State 4 |
| 10000 | Carrier #3 | State 5 |
| 10001 | Carrier #3 | State 6 |
| 10010 | Carrier #4 | State 1 |
| 10011 | Carrier #4 | State 2 |
| 10100 | Carrier #4 | State 3 |
| 10101 | Carrier #4 | State 4 |
| 10110 | Carrier #4 | State 5 |
| 10111 | Carrier #4 | State 6 |
| 11000 | Carrier #5 | State 1 |
| 11001 | Carrier #5 | State 2 |
| 11010 | Carrier #5 | State 3 |
| 11011 | Carrier #5 | State 4 |
| 11100 | Carrier #5 | State 5 |
| 11101 | Carrier #5 | State 6 |
| 11110 | Reserved | Reserved |
| 11111 | Reserved | Reserved |

As shown in Table 1, the 32 states formed by the 5 bits can be represented as “00000”-“11111”, in which “00000”-“00101” indicates resource allocations on Carrier #1, “00110”-“01011” indicates resource allocations on Carrier #2, “01100”-“10001” indicates resource allocations on Carrier #3, “10010”-“10111” indicates resource allocations on Carrier #4, “11000”-“11101” indicates resource allocations on Carrier #5, and “11110” and “11111” are reserved. State 1-State 4 in Table 1 respectively correspond to State “00”-State “11” defined in LTE-Advanced system.

With Carrier #1 as an example, State “00000” indicates this DCI being resource allocation on Carrier #1 and not triggering aperiodic CSI feedback; and State “00001” indicates this DCI being resource allocation on Carrier #1 and triggering aperiodic CSI feedbacks on downlink component carriers having SIB2 link (i.e., SIB2 linked) to an uplink component carrier (i.e., Carrier #1) indicated by the Carrier Indicator Field (CIF) in the current DCI.

State 5 and State 6 are two newly introduced states and are defined as triggering aperiodic CSI feedback in CoMP transmission modes. In the Embodiment 3 of the present disclosure, State 5 and State 6 can be defined by referring to State “10” and State “11” defined in LTE-Advanced systems. By RRC signaling, modes of aperiodic CSI feedback can be specifically configured. Still with Carrier #1 as an example, State 5, “00100”, can be defined as triggering CSI measurements and feedbacks on Carrier #1 in all measurement cells; and State 6, “00101”, can be defined as triggering channel state feedback on Carrier #1 in a specified measurement cell or cells.

The Embodiment 3 of the present disclosure provides an easy and feasible solution without increasing DCI Format payload at all, and without increasing the number of blind detections performed by user equipments. Also, there is no need to introduce one more CoMP transmission mode. Completely dynamic aperiodic CSI feedback in multiple coordinated cells multiple component carriers can be achieved.

### Embodiment 4

According to Embodiment 4 of the present disclosure, a sub-frame number is combined with a 2-bit aperiodic CSI request field included and defined in DCI Format to trigger aperiodic CSI feedback in multiple coordinated cells.

Specifically, single-cell aperiodic CSI feedback trigger and multiple-coordinated-cell aperiodic CSI feedback trigger are distinguished by sub-frame numbers in a time-division manner.

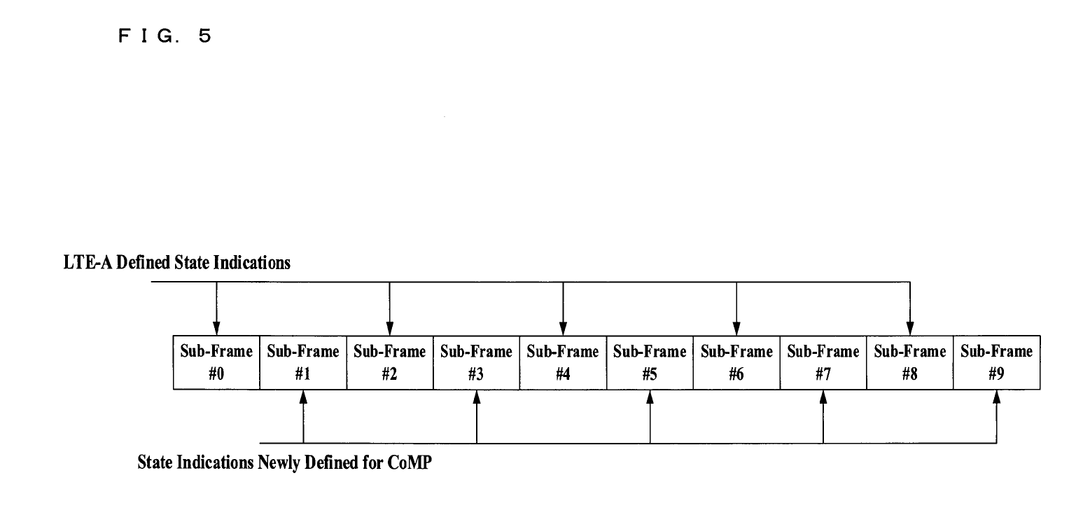

For example, FIG. 5 shows one example in which a sub-frame number and an aperiodic CSI request field are combined. As shown in FIG. 5, an odd-even frame manner is used wherein odd-numbered frames are used for triggering aperiodic CSI feedback in non-CoMP transmission modes, and even-numbered frames are used for triggering aperiodic CSI feedback in CoMP transmission modes. The CSI request field in the DCI Format in an odd-numbered frame is interpreted according to LTE-Advanced definitions. Whereas, the CSI request field in the DCI Format in an even-numbered frame is interpreted according to new definitions for multiple-coordinated-cell aperiodic CSI feedback.

For example, in a scenario of multiple-coordinated-cell aperiodic CSI feedback, the meaning of the 2-bit aperiodic CSI request field included in the DCI Format can be defined as follows.

State “00” indicates, not triggering aperiodic CSI feedback;

State “01” indicates, triggering aperiodic CSI feedback on downlink component carriers having SIB2 link (i.e., SIB2 linked) to an uplink component carrier indicated by a Carrier Indicator Field (CIF) in the current DCI in a part of measurement cells (specified by RRC signaling);

States “10” and “11”, whose meanings can be configured by RRC signaling. For example, by RRC signaling, State “10” and State “11” can be configured respectively as performing measurements and feedbacks on all component carriers in all measurement cells, and performing measurements and feedbacks on all component carriers in a part of measurement cells (specified by RRC signaling). Or as another example, by RRC signaling, State “10” and State “11” can be configured respectively as performing measurements and feedbacks on all component carriers in a part of measurement cells (specified by RRC signaling), and performing measurements and feedbacks on a part of component carriers (specified by RRC signaling) in a part of measurement cells (specified by RRC signaling).

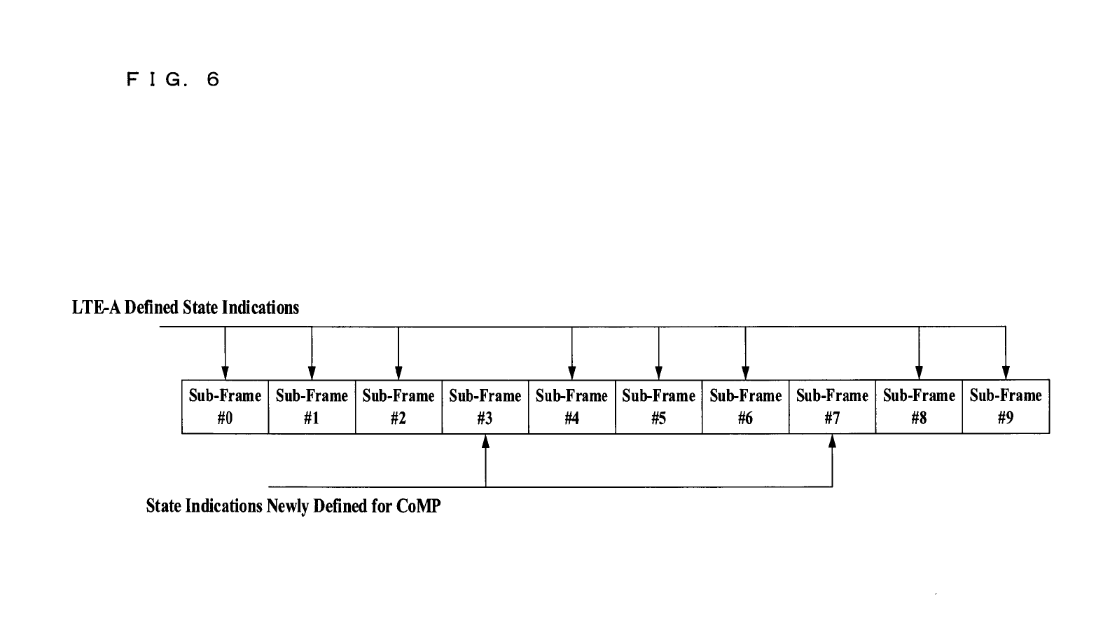

Similarly, FIG. 6 shows another example in which a sub-frame number and an aperiodic CSI request field are combined. In addition to the static definitions and the odd-even frame manner, some sub-frames can be semi-statically specified by a high layer signaling (RRC signaling). As shown in FIG. 6, Sub-Frame #3 and Sub-Frame #7 are semi-statically specified so that the 2-bit aperiodic CSI request fields included in the DCI Formats in these two sub-frames are used for triggering multiple-coordinated-cell aperiodic CSI feedback (for example, with the above definitions). But the 2-bit aperiodic CSI request fields included in the DCI Formats in other sub-frames are still used for triggering single-cell aperiodic CSI feedback (i.e., still with the definitions in LTE-Advanced systems).

With the above proposed various embodiments, the method for triggering aperiodic CSI feedback in CoMP transmission modes can be flexibly configured, and good backward compatibility can be obtained at the same time. The above method is simple and effective, the system design complexity is low, and the design requirements for practical systems and LTE-Advanced evolved systems are met.

A number of examples have been illustrated in the above description. While the inventor has tried to list the examples in association with each other, it does not imply that it is required for the listed examples to have such correspondence as described. A number of solutions can be achieved by selecting examples having no correspondence as long as the conditions underlying the selected examples do not conflict with each other. Such solutions are encompassed by the scope of the present disclosure.

The present disclosure has been described above with reference to the preferred embodiments thereof. It should be understood that various modifications, alternations and additions can be made by those skilled in the art without departing from the spirits and scope of the present invention. Therefore, the scope of the present disclosure is not limited to the above particular embodiments but only defined by the claims as attached.

1-10. (canceled)

11. A user equipment communicating with a base station, the user equipment transmitting specific channel state information from a plurality of channel state information
wherein the plurality of channel state information including a plurality of channel state information for the same component carrier; and
the specific channel state information is determined based on a value of a 2-bit CSI request field in Downlink Control Information (DCI).

12. The user equipment according to claim 11, wherein
the plurality of channel state information includes a plurality of channel state information for a downlink component carrier,
the downlink component carrier corresponds a uplink component carrier which is determined from the DCI and
the plurality of channel state information for the downlink component carrier are transmitted in a case that the value of the 2-bit CSI request field is “01”.

13. The user equipment according to claim 12, wherein uplink component carrier which is indicated by Carrier Indicator Field (CIF) in the DCI.

14. A user equipment communicating with a base station, the user equipment transmitting specific channel state information from a plurality of channel state information wherein
the plurality of channel state information includes channel state information for CoMP transmission mode; and
the specific channel state information is determined based on a value of a 2-bit CSI request field in Downlink Control Information (DCI).

15. A method for user equipment communicating with a base station, the method comprising transmitting specific channel state information from a plurality of channel state information
wherein the plurality of channel state information including a plurality of channel state information for the same component carrier; and
the specific channel state information is determined based on a value of a 2-bit CSI request field in Downlink Control Information (DCI).
